(19) United States
(12) Patent Application Publication
(10) Pub. No.: US 2020/0396193 A1
(43) Pub. Date: Dec. 17, 2020

(54) SYSTEM AND METHOD FOR CONNECTING USERS FOR A COMMON ACTIVITY

(71) Applicant: Carlos Toure Mayers, Brooklyn, NY (US)

(72) Inventor: Carlos Toure Mayers, Brooklyn, NY (US)

(21) Appl. No.: 16/900,092

(22) Filed: Jun. 12, 2020

Related U.S. Application Data
(60) Provisional application No. 62/860,333, filed on Jun. 12, 2019.

(51) Int. Cl. H04L 12/58; G06F 16/9535; G06F 16/9536; H04L 29/08; G06F 3/0488; H04L 12/18

(52) U.S. Cl. CPC H04L 51/20; G06F 16/9535; G06F 16/9536; H04L 12/1813; H04L 51/24; H04L 67/306; G06F 3/04883; H04L 51/32

(57) ABSTRACT

The invention provides system and methods for connecting users in a community for a common activity. The users are associated with user characteristics, which may include interest areas, classes registered, membership in clubs and the like. Activities are associated with activity characteristics, such as categories like Study, Entertainment, Sports, and so on. The user characteristics are matched against activity characteristics, and a notification is sent to the users having matching characteristics. The user is then allowed to respond to the notification by communicating an intent to join the common activity.

### CROSS-REFERENCE TO RELATED APPLICATIONS

This patent application claims the benefit of U.S. Provisional Patent Application No. 62/860,333, filed Jun. 12, 2019, contents of which are incorporated herein by reference.

### TECHNICAL FIELD OF THE INVENTION

The invention relates generally to instructions executable on an electronic medium and more specifically to instructions executable on a mobile device that provides a platform for users to connect for a common activity.

### BACKGROUND

Individuals are involved in several activities by themselves or as part of a group. In some instances, individuals performing an activity by themselves would generally benefit, if the same activity was done as part of a group. For example, studies have shown that jogging in small groups helps improve the outcome rather than when an individual jogs alone.

Also, in some instances, it is difficult to assemble a group of people for an activity. This is especially true for someone moving to a new location where the surroundings and people are unfamiliar to them. A very common situation where the individual finds themselves in such a spot would be freshman moving to campus for the first time. In such cases, individuals resort to asking random people (such as neighbors) for directions to find the right people. But this is intimidating to people with introverted personalities, who would rather not perform the activity at all or perform it alone.

Another very common approach is to post a note on community message boards. However, community message boards are often inundated with messages that a single message may be lost among the others. Further, community message boards are useful in cases where the proposed activity is quite into the future. For activities that are to be scheduled in a shorter time frame, such as within an hour, these message boards are not useful at all. For example, it cannot be used for a situation to bring people together for a pickup basketball game within say 20 minutes. Similarly, it is not very useful to find people who might be willing to split a pizza, as hunger alleviation is generally a short term proposition.

Websites and mobile applications have also been developed but none of them address this particular situation specifically. For instance, a message posted by an individual about wanting a jogging partner is sent to everyone accessing that site or application. A response from an interested individual is also sent to the entire group. There may be access limitations imposed by the application, but it is not particularly targeted towards interested individuals.

There is a need to build an electronic message board system that allows free exchange of posts about activity between interested users without necessarily involving others who are not actually interested.

### BRIEF DESCRIPTION OF THE INVENTION

In one aspect, the invention provides a method for connecting users in a community for a common activity. The method is typically enabled through a mobile application, a program run on a suitable computing device, or both. Each user in the community is associated with at least one user characteristic, and each activity is associated with at least one activity characteristic. When a user posts about an activity on the application, other users having user characteristic that matches the activity characteristic are notified about the common activity. Subsequently, other interested users can send a response communicating their intent to participate in the common activity, while those uninterested users can communicate their lack of interest through a suitable rejection message.

In another aspect, the invention provides a non-transitory machine readable medium storing instructions which when executed by a machine cause to enable the method of the invention as described herein.

In yet another aspect, the invention provides a system for connecting users in a community for a common activity based on the method of the invention.

### DRAWINGS

These and other features, aspects, and advantages of the present invention will become better understood when the following detailed description is read with reference to the accompanying drawings in which like characters represent like parts throughout the drawings, wherein:

FIG. 1 is a flowchart representation of exemplary steps involved in the method of the invention;

FIGS. 2a-2c show a typical login screen sequence of the application of the invention;

FIGS. 3a-3c are a depiction of the application of the invention wherein the user inputs profile data;

FIG. 4 is a depiction of the application of the invention showing activities;

FIG. 5 shows some exemplary categories of activities;

FIG. 6 shows an exemplary screen for creating a new activity;

FIG. 7 shows a search bar to enter search query by a user to find out relevant activities;

FIG. 8 is a depiction of a search for activities under a specific category;

FIG. 9 shows a depiction of the careen showing all activities happening soon;

FIGS. 10a-10c show a display of search results; and

FIG. 11 shows a depiction of an exemplary embodiment for a user to respond to a notification about an activity.

### DETAILED DESCRIPTION

The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the term “or” is generally employed in its sense including “and/or” unless the content clearly dictates otherwise.

As used herein, the term “community” means a group of people who have come together for a common cause. In one exemplary embodiment, community could mean all students enrolled in an academic institution. In another exemplary embodiment, community could mean all students living in a particular location such as a dormitory. In yet another exemplary embodiment, community could mean residents of a certain location. In a further exemplary embodiment, community could mean members of a certain social club. In yet another exemplary embodiment, community could mean people who have a similar goal or work towards a similar cause, such as members of a bird watcher's club. Thus, it can be seen that community could mean a group of people who are all located within a certain region or could be spread across the globe.

As used herein, the term “activity” means any pursuit to achieve certain purpose. Activity could mean a wide range of things to be done, and may include, for example, but not limited to, jogging, baking, dieting, studying, tutoring, driving and so on. Using a college campus as an example, a typical solicitation message for a studying activity will be posted by a student and might read as follows: “Need study partner for this week's final. If interested, please come to Room #101 tomorrow at 11 AM. Call 555-5555 if you need anything.” An alternate exemplary driving activity message might read as follows: “Need a ride to Buffalo, N.Y. for Spring Break, will split gas & food. Call 555-5555 if interested.”

In a typical scenario, someone else who is interested in the posted message would respond to it by calling or arriving at the posted location at the scheduled time to take up the offer. In the instant invention, this would be referred to as a “common activity”, wherein two people have found a single activity to be of common interest to both of them. It would be known to a person of skill in the art that while an example of two people has been used to illustrate the concept of common activity of the invention, it can be extended to more than two people as well. For example, a posting for a pickup basketball game at the park can bring together 5 or 10 or even more number of people. Thus, in this instance the common activity of pickup basketball game is common to the number of people who showed up for the game.

The community message board is a very useful way to establish links and make friends. Indeed it has been in use for several decades in many situations, including for example, bringing people together to find missing pets, hold candle light vigils, and so on. However, as already stated herein, one glaring deficiency of such message boards is that it requires a longer time frame to ensure it reaches the right set of people. It will not work for very short notice situations. The instant invention is capable of addressing the traditional community message board situation while extending its capabilities to the short term common activities as described herein.

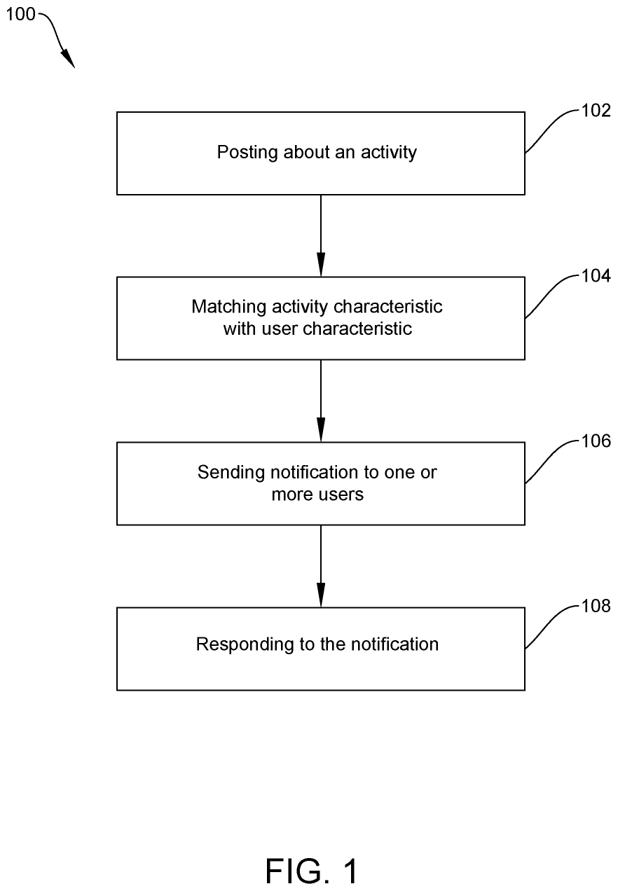

As noted herein, in one aspect the invention provides a method for connecting users in a community for a common activity. The method is best implemented as a set of instructions on a non-transitory medium capable of being read by a machine. In some embodiments, the method is implemented as a mobile application. To better illustrate the invention, embodiments have been described using a mobile application as an example. However, one skilled in the art can easily extend this to web based application using a browser interface as well without undue experimentation, which is encompassed to be within the scope of the invention. FIG. 1 is a flowchart representation of exemplary steps involved in the method of the invention, depicted generally by numeral 100.

User refers to a member of a particular community. In one exemplary embodiment, user could mean each student of a college, in another exemplary embodiment, it could mean each resident of a specific community, and so on. Each user is associated with at least one user characteristic. As used herein, user characteristic means characteristics of the user. It could refer to for example, but not limited to, gender, age group, race, specific zodiac sign, member of a fraternity, interest areas, student of a particular university, student of a graduating class of a certain year, and so on. One can easily infer that user characteristics can be used to mean any one characteristic or could mean more than one characteristic, such as for example, a student jogger in a specific university, or as another example, a chess club member of a particular university who has a preference to hang out at a particular local coffee shop.

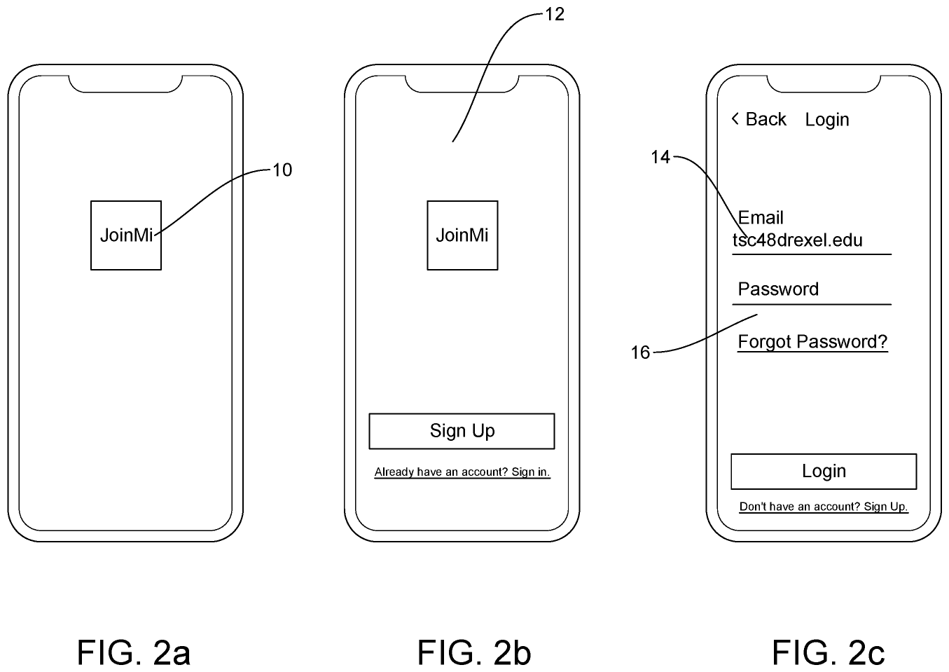

User characteristics may be obtained from the user when they fill out their user profile in a mobile application. In FIGS. 2a-2c show a typical login screen sequence of the application. FIG. 2a shows the application logo 10, which when tapped or clicked will open the application to the landing page. An exemplary landing page 12 is shown in FIG. 2b. User who does not have an account with the application can sign up through the standard procedures known in the art. Those who have signed up already can directly go to the sign-in page as shown in FIG. 2c. A typical username is the email id of the user depicted by numeral 14. Login is completed by keying in the password in the space provided, depicted by numeral 16 in FIG. 2c. One skilled in the art can also appreciate that the login procedures can be sped up using known techniques such as biometric sign-ins, facial recognition, and so on. All such known techniques are envisioned to be encompassed within the scope of the invention.

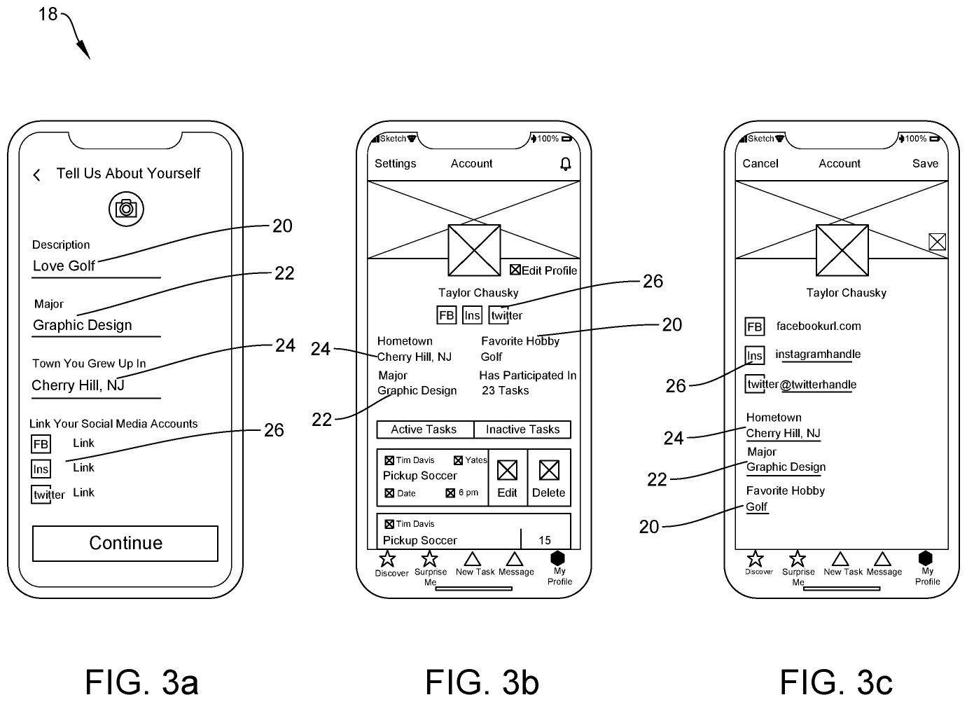

FIGS. 3a-3c are a depiction of the application of the invention wherein the user inputs profile data depicted generally by numeral 18. FIG. 3a is a depiction of a user profile input, while FIG. 3b is a depiction of a user profile edit page and FIG. 3c is a depiction of user profile page after inputting and accepting all the changes. Some exemplary information such as interested sports depicted by numeral 20, major chosen at the university depicted by numeral 22, city and state of origin depicted by numeral 24, etc. are shown herein. Further profile information can be obtained by scraping information from social media, whose links are to be inputted in the allotted place on the screen of the invention and depicted by numeral 26. All such information is then used to build user characteristics in the application of the invention. In a typical implementation of the method of the invention, the application is run from a centralized server where the user characteristics are stored. A processor is made available that is capable of processing all the data that flows through the server. For example, the processor is capable of knowing all the users who have one particular characteristic, such as all freshman students in one example, all sophomores who are also in the cheerleading squad in another example, and so on.

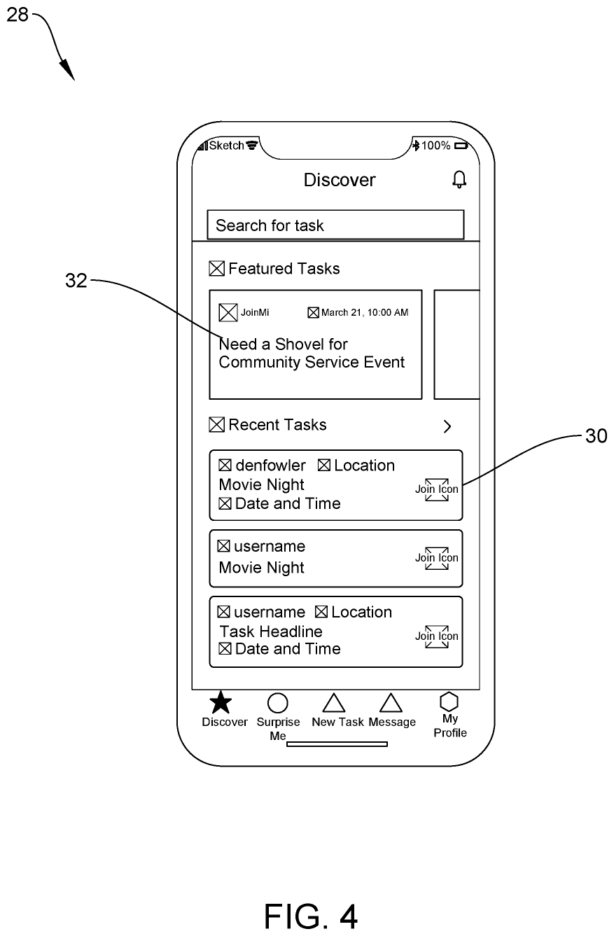

The application of the invention further includes an activity associated with the users in the community. Each activity is associated with at least one activity characteristic. The server has all activity related information stored for enabling the further steps of the invention as described herein. A user may post about an activity in the application to elicit interest from other users. Turning to the drawings again, FIG. 4 is a depiction of the application of the invention showing activities generally referred to by numeral 28. In the exemplary embodiment shown in FIG. 4, an exemplary activity ‘movie night’ is used for illustration purposes, depicted by numeral 30.

As stated herein, each activity is associated with at least one activity characteristic. In the example for activity given herein, the activity ‘movie night’ is associated with activity characteristics ‘date’ and ‘time’ Other activity characteristics may include, for example, a local event in particular location. For example numeral 32 in FIG. 4 depicts an activity of ‘need a shovel’, for which the activity characteristics may include location, actions involved (such as digging, planting, sowing, burying etc.), and so on.

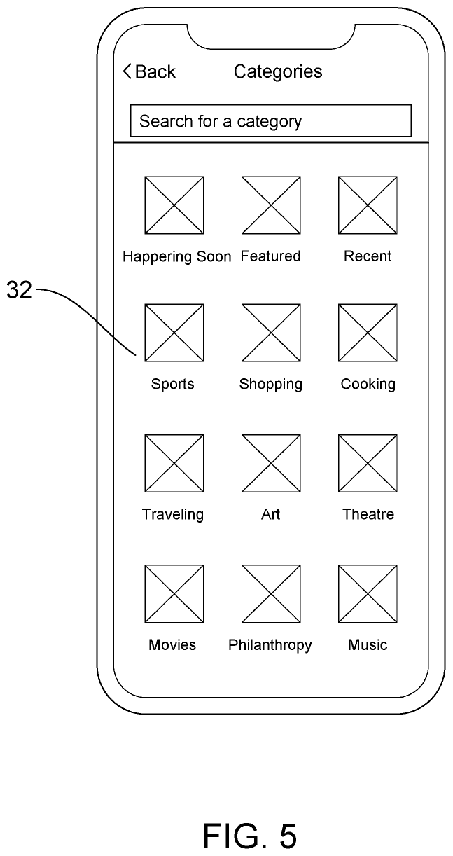

One skilled in the art will immediately appreciate that the activities described can be separated into distinct categories. Such categorization offer a number of distinct advantages, such as making it easily searchable, facilitate organization for analytics, simplify retrieval for display, and other such good reasons. Some exemplary categories may include, but not limited to, sports, dining, entertainment, art, music, gaming, etc. These categories are also one of the activity characteristics. FIG. 5 shows some exemplary categories of activities useful in the application of the invention, represented generally by numeral 34. In some embodiments, the processor can automatically extract characteristics about an activity based on some basic information made available. For example, the application can be programmed such that a post that includes the word ‘Loews’ to automatically apply the category ‘movies’ to the post. In other embodiments, the application can ensure some posts cannot be made unless some specific related information is also made available, such as a date and time, and even a title for the movie.

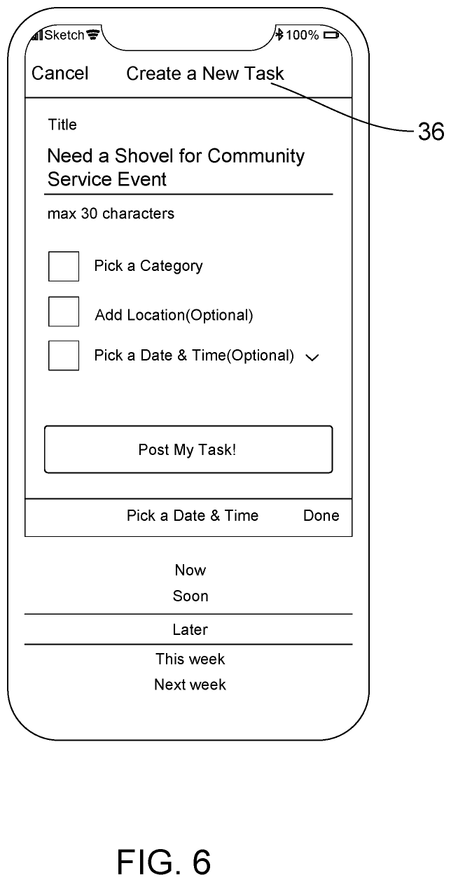

As already noted, the method of the invention involves receiving a post about an activity by a user, shown in FIG. 1 by numeral 102. FIG. 6 shows an exemplary screen for creating a new activity (task), generally depicted by numeral 36. Some exemplary inputs include text to be displayed, category of the activity, location of the activity, date & time (if applicable). Other such inputs will become apparent to one skilled in the art, and is encompassed within the scope of the invention. Such inputs related to the activity may be used to generate activity characteristics for that particular activity.

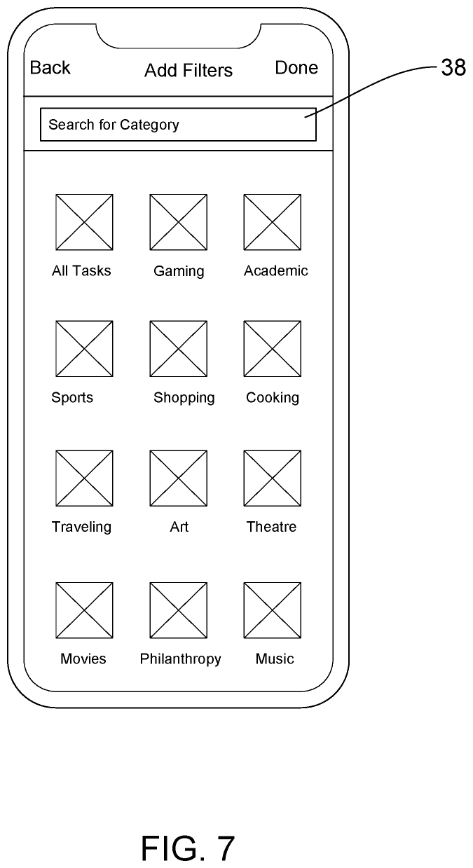

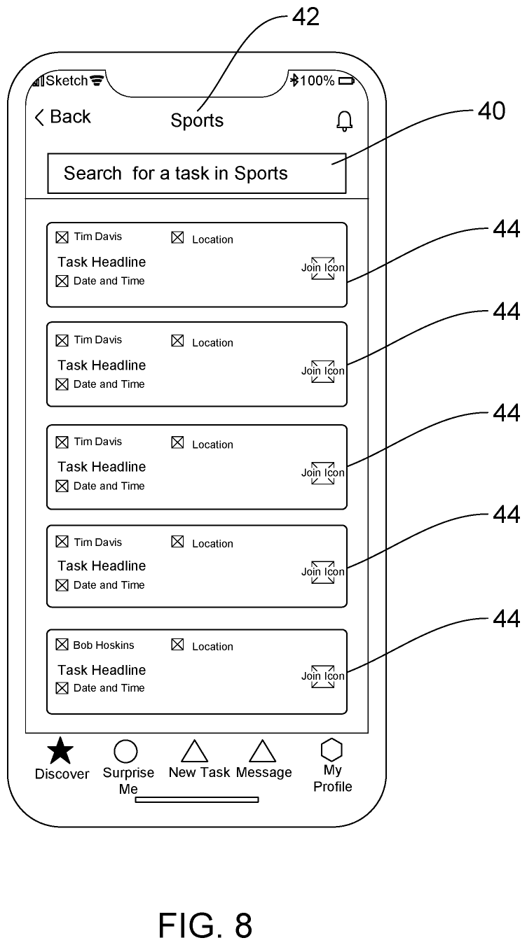

FIG. 7 shows a search bar generally represented by numeral 38, wherein a user can enter search queries to find out relevant activities. As described herein, search queries are also considered as one of the user characteristics. Search queries can be of any form, and may include keywords, location, date, time, categories, and so on. In one exemplary embodiment, the search query may be keyword ‘golf’. In another exemplary embodiment, the search may be specifically for activities happening ‘today’. FIG. 8 is a depiction of a search for activities under a specific category in a further exemplary embodiment of the invention. In the example shown, the search terms can be input into the query box 40 be for any activity under the category ‘sports’ depicted by numeral 42. Combinations of search inputs are also envisioned as part of the invention. Thus, for example, a keyword ‘pool’ may be combined with date ‘May 18, 2020’ and time ‘9:00 PM’ and the search can be restricted to the category ‘sports’.

When such a search is conducted on the application of the invention, the processor would retrieve only those search results that are limited to those activities that have activity characteristics matching exactly with or closely associated with the search queries, or user characteristics, as shown in FIG. 1 by numeral 104. In FIG. 8, the search results are generally depicted by numeral 44. In this manner, all those activities that are relevant to a particular user will be displayed.

In a further embodiment, users having characteristics matching those activities having relevant characteristics are notified about the activity, shown in FIG. 1 by numeral 106. Typical notification includes a display on the user's mobile device. Thus, for example, a user who has mentioned a passion for movies (user characteristic) may be shown the activity movie night (category ‘movies’ which is also an activity characteristic). This is included in the application of the invention as a feature termed ‘Surprise Me’ feed, wherein the application sends a notification to the user about a particular activity without the user actually searching for a relevant activity. In another exemplary embodiment, for all male users, notifications that specifically mention about male users or unisex activities will be displayed, while those specifying female users will not be shown. The application will ensure relevance of the activity based on past some aspects of the user profile such as activities that a user has joined in the past, for example. In one exemplary embodiment, if the application knows about an upcoming midterm exam (either from another user's post, or through other means such as a dedicated exam schedule module within the processor used to run the application), one users major is Computer Science, the user has joined a task in the academics category previously, and is an avid user of the app, the application can estimate the user interest level about a Math study group post to be very high, and bring such a post to the top of their feed or even sending them a notification about it.

In some instances, users may show multiple interests. The application can then build the capability of discerning the order of interests for a particular user. This may be achieved by various factors, which may include for example the number of minutes spent on each a particular activity or a category of activity. Thus, a user spending 2 hours reading about activities related to movies as opposed to only one hour related to sports may be preferentially shown movie related activities, or at least all movie related activities may be shown at the top, while sports related activities are shown next in order, and so on. Other factors such as timeliness may also be a factor in displaying activities. For example, during an exam week, the application may suppress posts related to movies, and increase weightage on posts related to studies related to specific subjects. In yet another example, during the ‘March Madness’ period, posts related to college basketball may be shown higher on the list, while posts related to football drafts or baseball preseason may be lower for a user who has these user characteristics defining them in the application. Other such examples that define the order of posts will become known to one skilled in the art, and is envisioned to be encompassed within the scope of the invention.

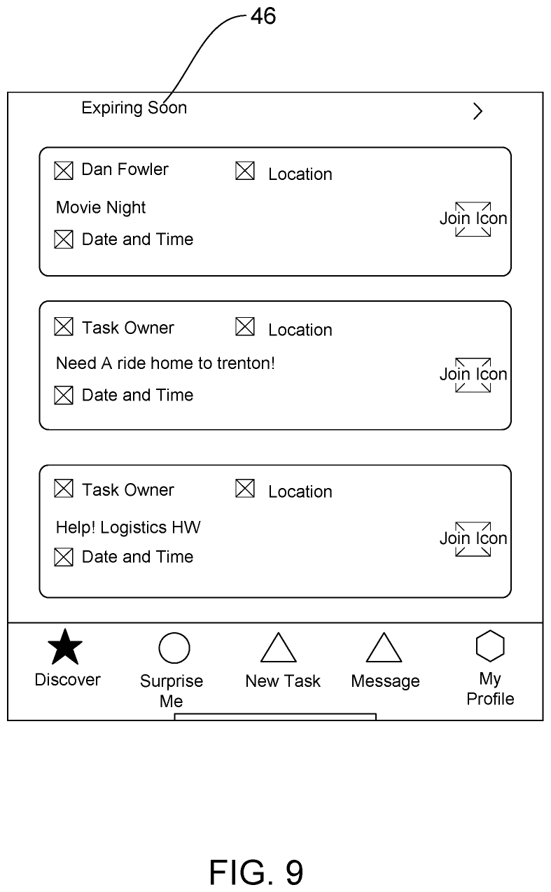

The timing of the notification can be programmed based on the requirements of the user posting it as well as the settings on the application on the mobile device of the user viewing it. Thus, it could appear as soon as it posted, and/or as a reminder at a preset time before the event, such as, for example, 1 hour before the event. The nature of the notification and/or reminder can also be suitably programmed. In one embodiment, notifications are displays on the user's mobile phone, and reminders are flashing lights. In another embodiment, notification is a display with a flashing icon, and reminders including a sound tone. Exact nature of the notification and reminder may depend on the user posting the message, user settings on the respective applications, and other such factors. In yet another exemplary embodiment of the invention, activities having matching characteristics to the user characteristics and that are occurring soon may be displayed automatically on the user's screen. The definition of ‘soon’ may be user defined or may be predefined as occurring within an hour, or within 3 hours, or within 30 minutes, etc. FIG. 9 shows a depiction of the screen showing all activities happening soon, which is depicted by numeral 46.

In some embodiments of the invention, the display of activities can be rendered minimal such that it does not require extensive scrolling by the user. This is meant to catch the attention of the user quickly, as it is known among application developers and programmers that too much scrolling leads to ‘zombie scrolling’ which is to be generally avoided. Thus in one exemplary embodiment of the invention, only the title, date, time and location of the activity are displayed. Other important characteristics such as categories can also be included in the main display. Depending on the nature of the activity, the category could also be an important differentiator for a user. For example, an activity ‘movie night’ under the category ‘entertainment’ is very different from n activity ‘movie night’ under the category ‘study group’ (for an arts class). The text can also be appropriately bolded and size may be made bigger for some sections, such as the title, and the others can be made smaller. Images may also be included in the display to attract attention.

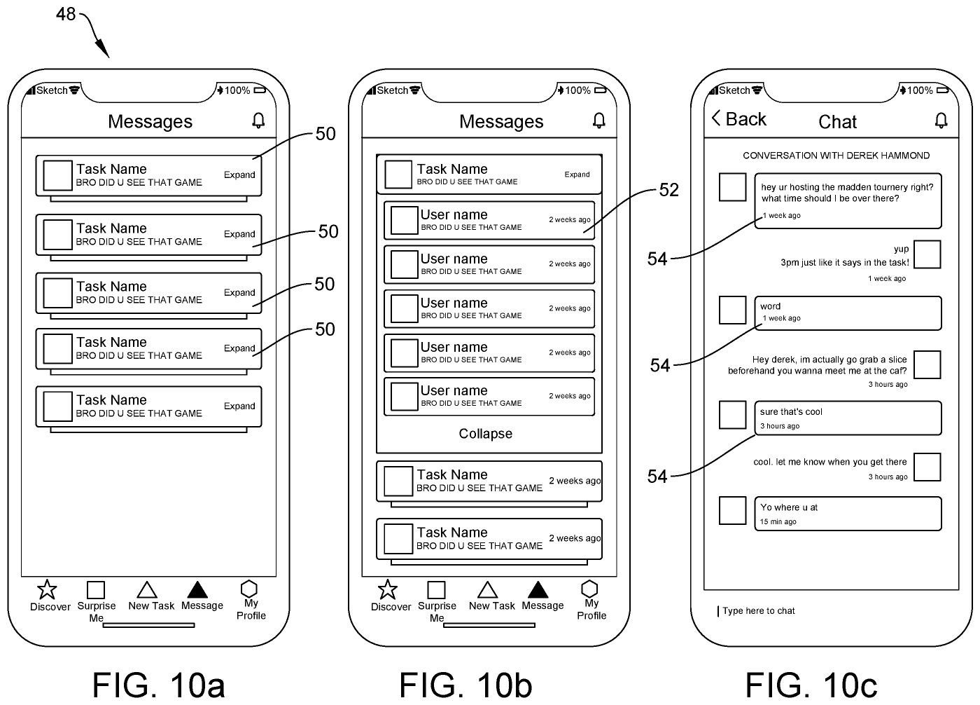

In an exemplary embodiment of the invention, the display of search results is shown in FIGS. 10a-c and depicted generally by numeral 48. FIG. 10a shows category-wise grouping of all the notifications, wherein the categories are depicted numeral 50. User can then click or tap on a specific category to expand the view of that particular category to reveal all the messages within that category, shown in FIG. 10b and generally depicted by numeral 52. Messages may be arranged by the user posting the messages or the time of posting, depending on the settings of the group, settings on the user's device and other such factors that would become apparent to one skilled in the art. FIG. 10c shows the detail of all chat messages within a particular category and with a specific user, generally depicted by numeral 54. Other such variations for displaying the most appropriate text and images will become apparent to one skilled in the art and are envisioned to be encompassed within the scope of the invention.

The display of activities may also be made time sensitive. Thus, once the time for a particular activity expires, that activity is removed from active display, and moved to a different location such as archive. Alternately, it can be deleted entirely to make extra space on the device, and/or the server.

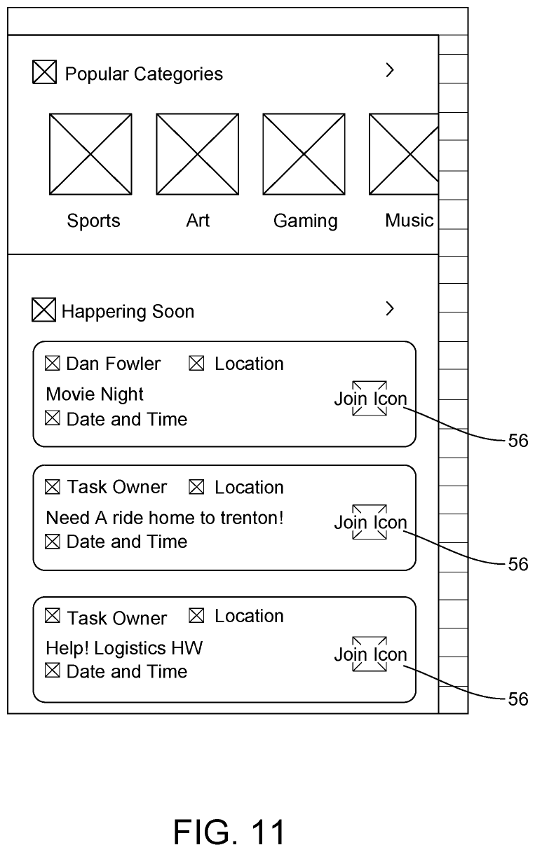

Once the user has read the message related to the activity, the user can then choose to respond to it which will be received by the application for further processing, represented by numeral 108 in FIG. 1. The response may be one of accepting to join the activity or declining it. The application can make a determination as to whether to send the response to the original user who posted the message, or to other relevant users who have already responded to the post, or to all users on the group. The number of users who are allowed to view the response of a user can be determined by the user posting the message, the user responding to the post, or other such settings. Hierarchy of whose settings will override the other user's settings in case of conflict can also be predetermined at an early stage, such as when the user posts about the activity, or by a responding user as a global setting, and so on. In one embodiment of the invention, a ‘Join’ icon is provided on the message in the application, which when tapped or clicked will automatically register in the application as the user having joined in for the common activity. FIG. 11 shows a depiction of an exemplary embodiment wherein the ‘Join’ icon 56 is provided for the user to click or tap to communicate intent to join the common activity.

In some embodiments, the response can be in the form of a swipe gesture. For example, a swipe gesture to the right can be used to communicate acceptance, while swiping left can be used to mean declining. In other embodiments, a tap gesture can be used to communicate intent. For example, a single tap can be programmed to mean acceptance while a double tap could mean decline. Other forms of communication modes may also be used to respond, such as but not limited to, text messages, emojis such as a thumbs up sign, voice message, image messages, bitmojis, and so on. One skilled in the art would appreciate that the nature of the gesture to communicate intent can be customized by the user in their device under the settings tab. For example, one user might prefer a right swipe to indicate acceptance, while another user might prefer it to indicate rejection. It would also be known to one skilled in the art to use a confirmation pop-up once a response action has been initiated by the user.

In further embodiments, a third option of ‘tentative’ is also provided to the user. This option is for the users whose plans are not completely confirmed, and wish to leave their options open to make a decision at a later time. In such instances, a reminder may be sent to the user by the mobile application. The reminder may be in the form of a message, a flashing icon, vibrations, a sound reminder, and other forms, and combinations thereof.

Once a response has been posted by the user for a particular activity, subsequent messages can then be displayed or blocked to the user by the mobile application. Thus, if the user accepts the common activity, then a confirmation message may be sent to the user posting the message, other users who have accepted to participate in the common activity, as well as the user accepting the common activity. Alternately, a public message can be posted on the electronic message board for all users to view it. The extent of visibility of a response can be controlled by the posting user, the responding user, or an administrator, depending on various factors such as nature of activity, user preferences, and so on.

It would also be known to one skilled in the art that maintaining a history of common activities attended and/or rejected by a user may be saved. This history may then be used as a user characteristic to make future recommendations for activities.

In further embodiments, the extent of activity of a user on the application is also considered as a user characteristic by the application. Thus, a very active user may be notified about more activities, whereas sparsely active users may be notified about less activities. The application may also be programmed such that sparsely active users are notified about more activities in an attempt to make them more active. Further, based on a particular user's past activity, notifications about a particular category of activity may be preferentially displayed on the mobile phone. In this manner, the application is designed to notify users about more relevant activities related to their specific interest areas.

In another aspect, the invention provides a system for connecting users in a community for a common activity using the method of the invention as described herein. As already stated herein, the system used to implement the method of the invention may be in the form of a mobile application, in the form of a web-based application, or a downloadable software used on a personal computer or a tablet. Thus, the platforms on which the system would work include for example, Windows, iOS, Android, Linux, etc. It would also be known to one skilled in the art to implement the system across all available platforms and allow for a seamless experience for the users in a community across all the platforms.

The methods described herein and the system of the invention allow for rapid exchange of information related to an activity by users in a community with other users in the community. This then enables users having common interests to come together for an activity. The methods of the invention overcome any limitations that traditional message boards or group chats impose by targeting specific users having common interests. Further, the methods and system of the invention allows for bringing together users with similar interests for short term common activities, such as sharing costs for a pizza, having leftover perishable food item from a party like a cake, or sharing a cab ride to a common destination within the next 1 or 2 hours.

While only certain features of the invention have been illustrated and described herein, many modifications and changes will occur to those skilled in the art. It is, therefore, to be understood that the appended claims are intended to cover all such modifications and changes as fall within the true spirit of the invention.

I claim:

1. A method for connecting users in a community for a common activity, wherein each user is associated with at least one user characteristic, wherein each activity is associated with at least one activity characteristic, the method comprising:
receiving a post about the activity on the mobile application from a first user;
matching the activity characteristic with at least one user characteristic of one or more other users in the community to identify the common activity;
sending a notification to a mobile device of the one or more other users about the common activity; and
receiving a response to the notification from the mobile device of the one or more other users, wherein the response includes communicating an intent to join the common activity.

2. The method of claim 1 wherein the community is an academic institution.

3. The method of claim 1 wherein the at least one user characteristic is based on a user profile.

4. The method of claim 1 wherein the at least one user characteristic further comprises a search query.

5. The method of claim 1 wherein the sending the notification comprises sending a private message, posting a message on an electronic message board provided, or both.

6. The method of claim 1 wherein the receiving the response is based on at least one of a swipe gesture, a tap gesture, sending a private message, posting a message on an electronic message board, or combinations thereof by the one or more other users.

7. A non-transitory machine readable medium storing instructions which when executed by a machine cause the machine to:
post a message about an activity by users in a community, wherein the activity is associated with activity characteristics, and each user is associated with user characteristics;
match the activity characteristics with user characteristics to identify a common activity among users;
send notification to users associated with the user characteristics about the common activity; and
receive an indication from the users to join or reject the common activity.

8. A system for connecting users in a community for a common activity, wherein each user is associated with at least one user characteristic, and the activity is associated with at least one activity characteristic, the system comprising providing a non-transitory machine readable medium storing instructions which when executed by a machine cause the machine to:
allow users to post a message about the activity;
match the activity characteristics with user characteristics to identify the common activity;
send notification to users associated with the user characteristics about the common activity; and
receive an indication from the users to join or reject the common activity.

9. The system of claim 8 wherein the community is an academic institution.

10. The system of claim 8 wherein the at least one user characteristic is based on a user profile.

11. The system of claim 8 wherein the at least one user characteristic further comprises a search query.

12. The system of claim 8 wherein the notification is a private message, a message on an electronic message board, or both.

13. The system of claim 8 wherein receiving the indication to join or reject the activity is based on at least one of a swipe gesture, a tap gesture, sending a private message, posting a message on an electronic message board, or combinations thereof.
